(19) United States
(12) Patent Application Publication
(10) Pub. No.: US 2026/0197379 A1
(43) Pub. Date: Jul. 9, 2026

(54) Folding Device

(71) Applicant: Microsoft Technology Licensing, LLC, Redmond, WA (US)

(72) Inventors: Daniel C PARK, Woodinville, WA (US); Eric WITT, Redmond, WA (US); Devin CAPLOW-MUNRO, Seattle, WA (US); Denys V YAREMENKO, Carnation, WA (US); Brett TOMKY, Seattle, WA (US); Karsten AAGAARD, Monroe, WA (US); Tung Yuen LAU, Hong Kong (CN)

(73) Assignee: Microsoft Technology Licensing, LLC, Redmond, WA (US)

(21) Appl. No.: 19/134,171

(22) PCT Filed: Dec. 22, 2022
(86) PCT No.: PCT/CN2022/140965

§ 371 Date: May 29, 2025

(51) Int. Cl. H04M 1/02

(52) U.S. Cl. CPC H04M 1/022; H04M 1/0268

(57) ABSTRACT

The description relates to hinged devices, such as hinged computing devices. One example can include a first portion associated with a first axial timing surface and a second portion associated with a second axial timing surface. The example can also include a clutch stack spanning between the first portion and the second portion and a timing shuttle configured to engage the first and second axial timing surfaces to synchronize rotation of the first and second portions through a range of rotation. The example can include orientation dependent cams that control compression of the clutch stack as the first and second portions rotate through the range of rotation.

### BACKGROUND

Many computer form factors such as smart phones, tablets, and notebook computers can provide enhanced functionality by folding for storage and opening for use. For instance, the folded device is easier to carry and the opened device offers more input/output area.

### SUMMARY

This patent relates to hinged devices, such as hinged computing devices. One example can include a first portion associated with a first axial timing surface and a second portion associated with a second axial timing surface. The example can also include a clutch stack spanning between the first portion and the second portion and a timing shuttle configured to engage the first and second axial timing surfaces to synchronize rotation of the first and second portions through range of rotation. The example can include orientation dependent cams that control compression of the clutch stack as the first and second portions rotate through the range of rotation.

This example is intended to provide a summary of some of the described concepts and is not intended to be inclusive or limiting.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced. Where space permits, elements and their associated reference numbers are both shown on the drawing page for the reader's convenience. Otherwise, only the reference numbers are shown.

FIGS. 1A-1C, 2B, 3B, 4B, and 5B show perspective views of example devices in accordance with some implementations of the present concepts.

FIGS. 2C-2E show exploded perspective views of example devices in accordance with some implementations of the present concepts.

FIGS. 2A, 3A, 4A, and 5A show elevational views of example devices in accordance with some implementations of the present concepts.

FIG. 2F shows an exploded elevational view of an example device in accordance with some implementations of the present concepts.

### DESCRIPTION

The present concepts relate to devices, such as computing devices employing timed hinge assemblies that allow rotation of first and second device portions through a range of orientations (e.g., relative angles). In addition to timing or synchronizing rotation of the first and second portions, the hinge assembly can provide friction relating to resistance to rotation (e.g., frictional torque) based upon orientation. In a first sub-range of orientations, the friction can maintain the first and second portions at whatever orientation the user positions it. At another sub-range of orientations, such as approaching zero degrees, the hinge assembly can provide less friction and can facilitate the device popping open from the closed orientation when the user opens it. These and other aspects are described below by way of example.

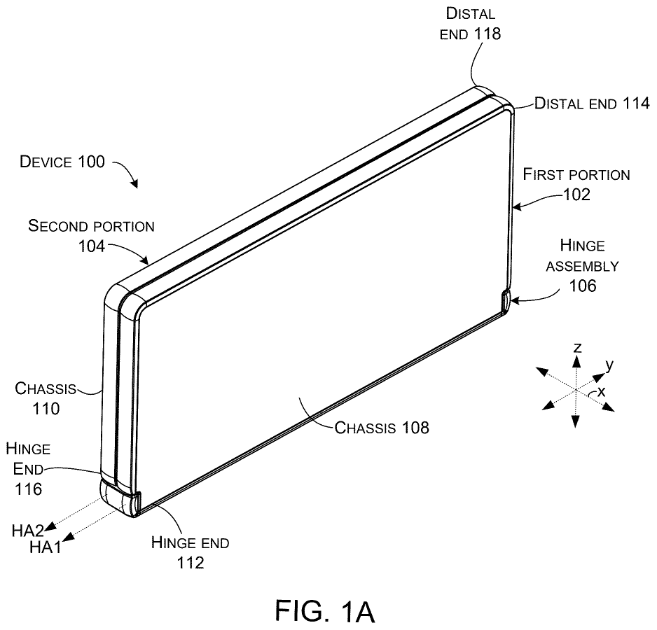

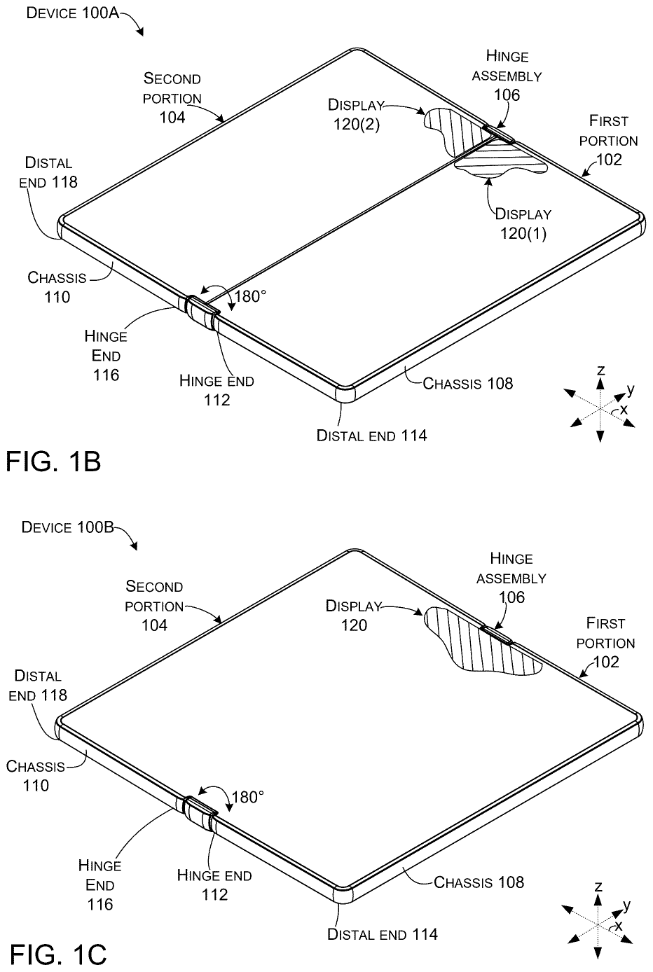

Introductory FIGS. 1A-1C collectively show two example device configurations. The device 100A includes first and second portions 102 and 104 that are coupled by a hinge assembly 106A to allow rotation through a range of orientations (e.g., relative angles). The first portion 102 includes a housing or chassis 108 and the second portion 104 includes a housing or chassis 110. The first portion 102 extends from a hinge end 112 to a distal end 114 and the second portion 104 extends from a hinge end 116 to a distal end 118. The hinge assembly 106 defines hinge axes (HA).

FIG. 1A shows a device 100A in a closed or approximately zero-degree orientation. As used herein the approximately zero-degree orientation can be exactly zero degrees and can also include orientations within +/− about three degrees (e.g., −3 degrees to +3 degrees). FIG. 1B shows a first variation of device 100A in an open orientation of about 180 degrees and FIG. 1C shows a second device variation of device 100B in an open orientation of about 180 degrees. As used herein the approximately 180-degree orientation can be exactly 180 degrees and can also include approximate orientations within +/− about five degrees (e.g., 175-185 degrees).

FIG. 1B shows example device 100A with a first display 120(1) positioned on the chassis 108 of the first portion 102 and a separate and distinct second display 120(2) positioned on the chassis 110 of the second portion 104. The displays 120(1) and 120(2) abut at the hinge assembly 106A in the 180-degree orientation.

FIG. 1C shows example device 100B with a single display 120 spanning from the first portion 102 over the hinge assembly 106B to the second portion 104. The single display 120 can be a flexible display that can bend at the hinge assembly 106B when the device is closed. The hinge assembly 106B can provide space for an enlarged minimum bend radius for the display 120 (e.g., teardrop shape) over the hinge assembly 106 as the device 100B is closed to reduce potential damage, such as crimping of the flexible display. In both of the illustrated configurations of FIGS. 1B and 1C, portions of the hinge assemblies 106A and 106B are visible at the edges of the device. In other implementations, the hinge assembly may not be readily visible.

The hinge assemblies 106 can satisfy various design parameters by providing technical solutions, such as providing relatively high friction (e.g., frictional resistance to rotation or frictional torque) at some orientations (e.g., a first sub-range of orientations) to maintain the device portions in a given orientation. For instance, if the user places the device in a 100-degree orientation, the friction (e.g., rotational torque) provided by the hinge assembly can maintain that orientation until the user changes it. Some implementations may employ a detent mechanism at a specific orientation of the first sub-range of orientations, such as at or close to 180 degrees (e.g., fully open). The detent mechanism will help hold the device at fully open and give a positive user experience feedback that the device is fully open.

The hinge assembly may also produce relatively less friction at some other orientations (e.g., a second sub-range of orientations), such as a closed orientation, to facilitate ease of opening. For example, the high friction sub-range provides a high friction sub-range of rotation, such as from 180 degrees to 15 degrees and then a low friction sub-range reduces the amount of friction, such as at 15 degrees to zero degrees.

This low friction sub-range may correspond to a pop-up feature. For instance, the device may include a lock that automatically engages when the device is closed (e.g., closed orientation). When the user releases the lock, stored energy, such as energy stored in the bent flexible display may automatically pop the device open a few degrees, such as from zero degrees to 10 degrees. The low friction sub-range avoids ‘countering’ the pop-up force and allows the stored energy to readily open the device a few degrees.

The hinge assembly can also synchronize (e.g., time) rotation of the first and second portions so that rotation of one portion produces simultaneous and equal rotation of the other portion. The present hinge assembly concepts can provide synchronization while providing minimal timing backlash to prevent motion of one device half from being out of sync with the other half. Out of sync motion is unattractive and can lead to display damage. The present concepts can achieve these technical solutions on a device that is relatively thin in the z reference direction.

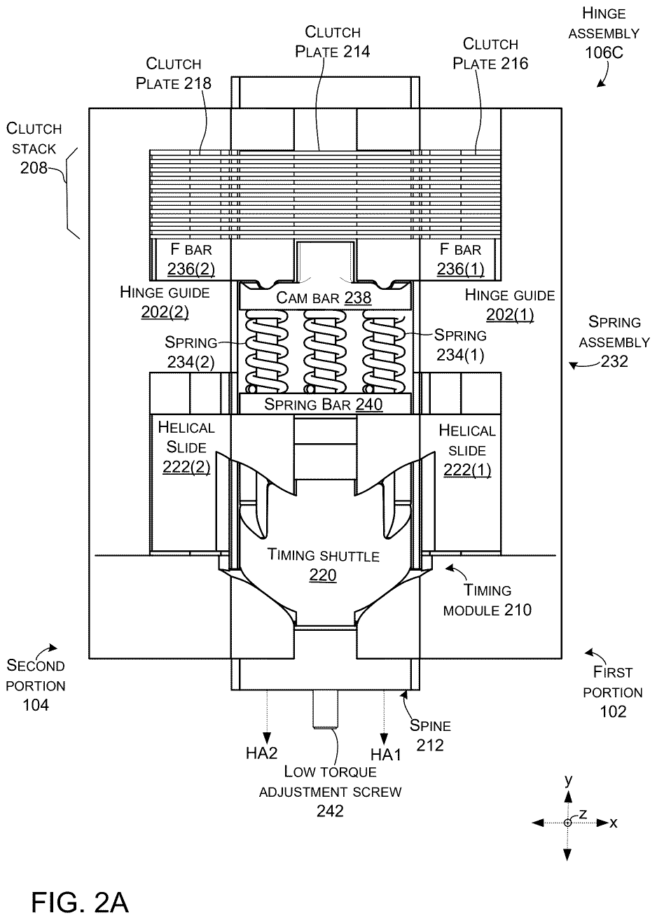

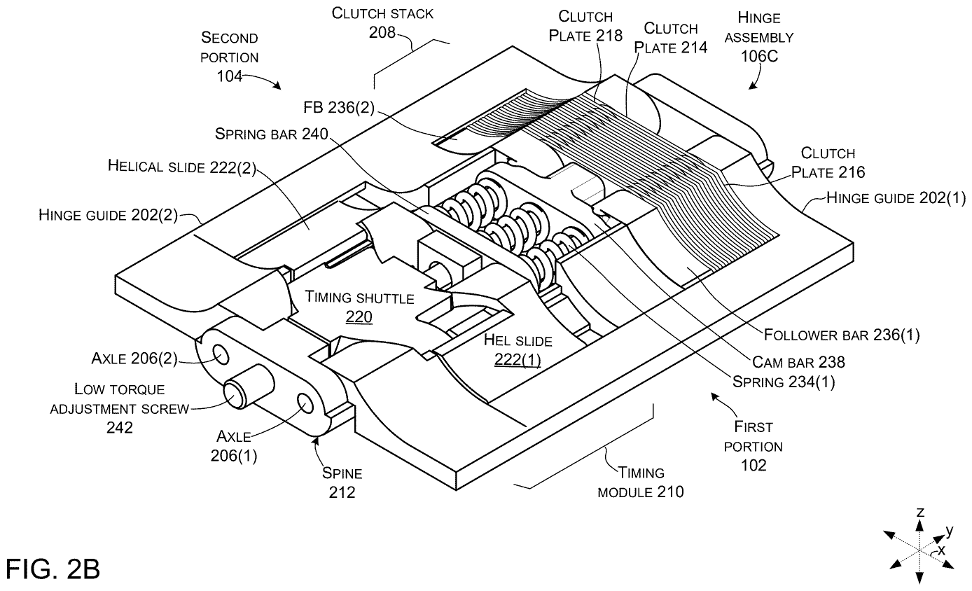

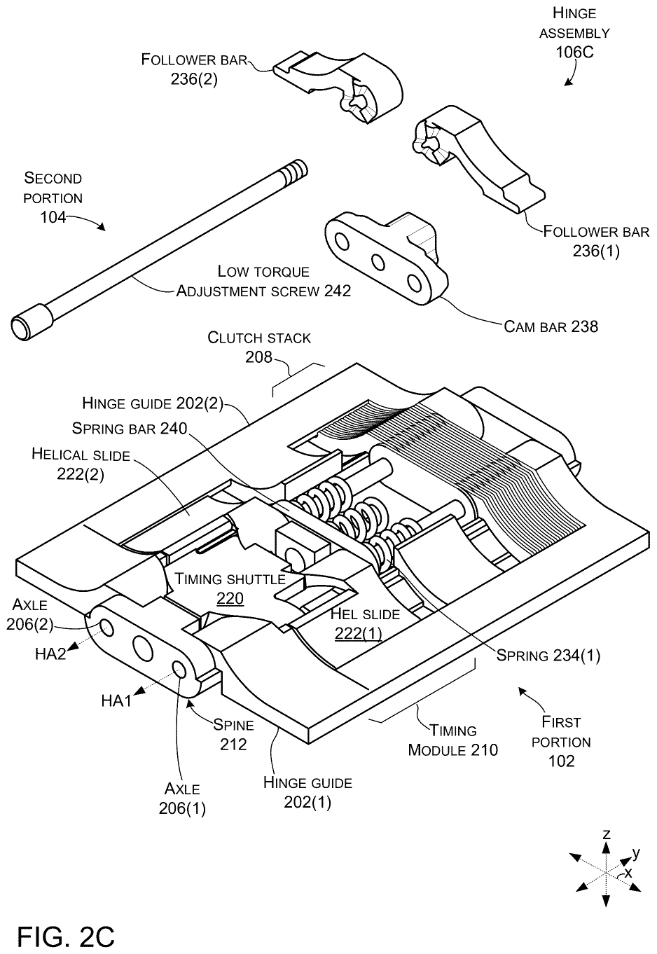

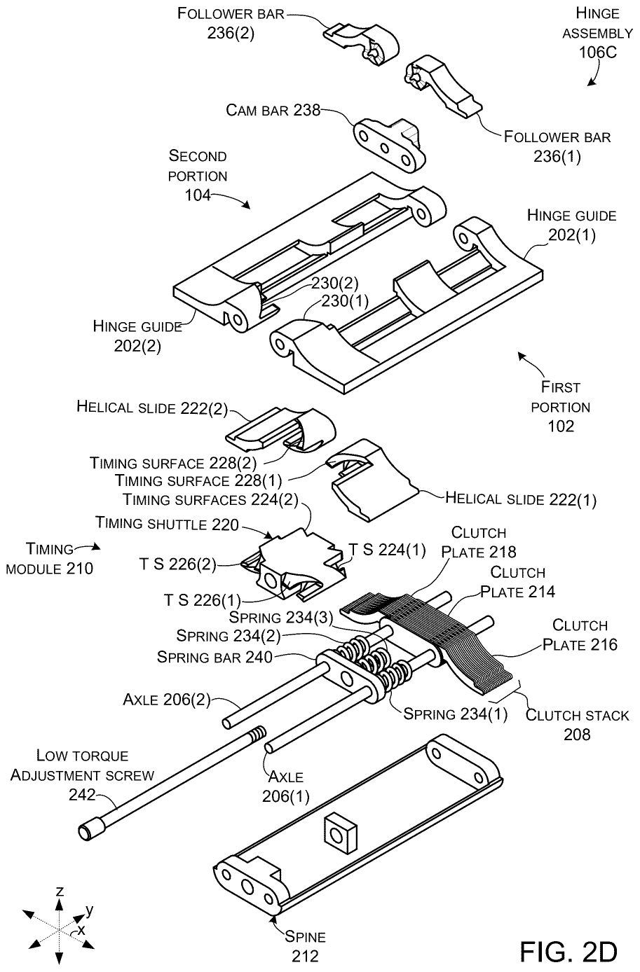

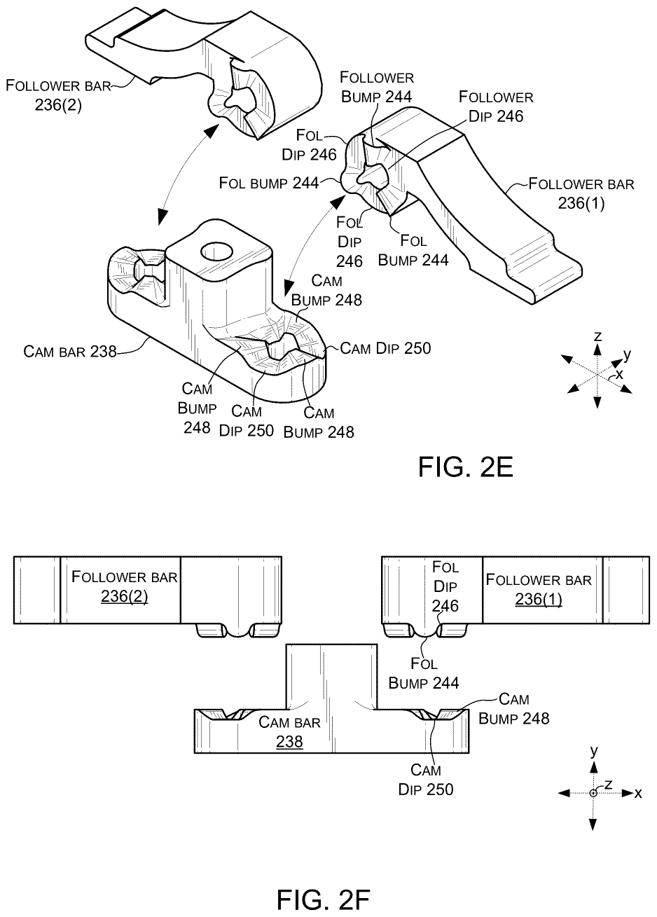

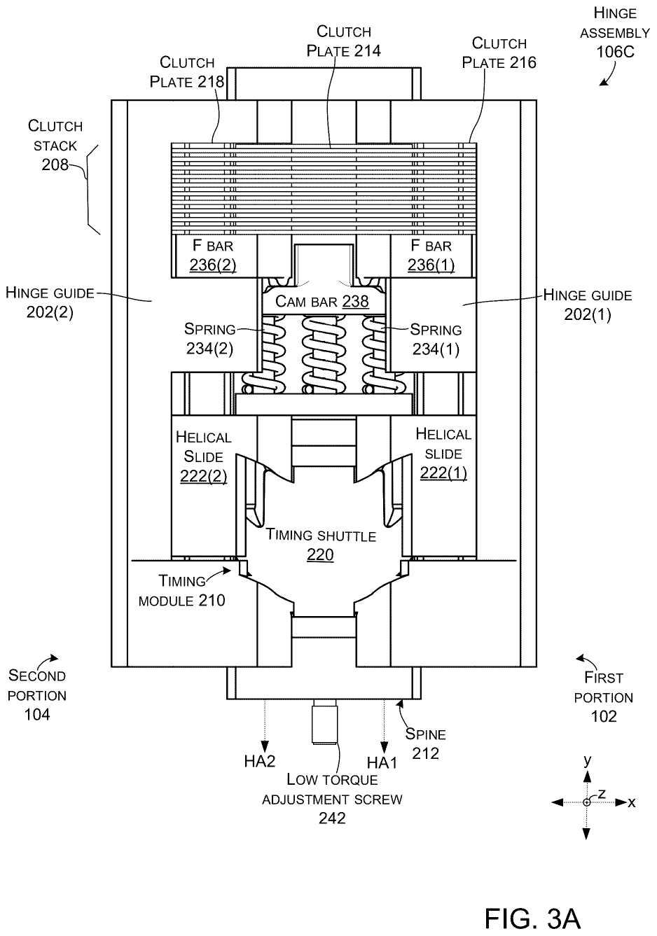

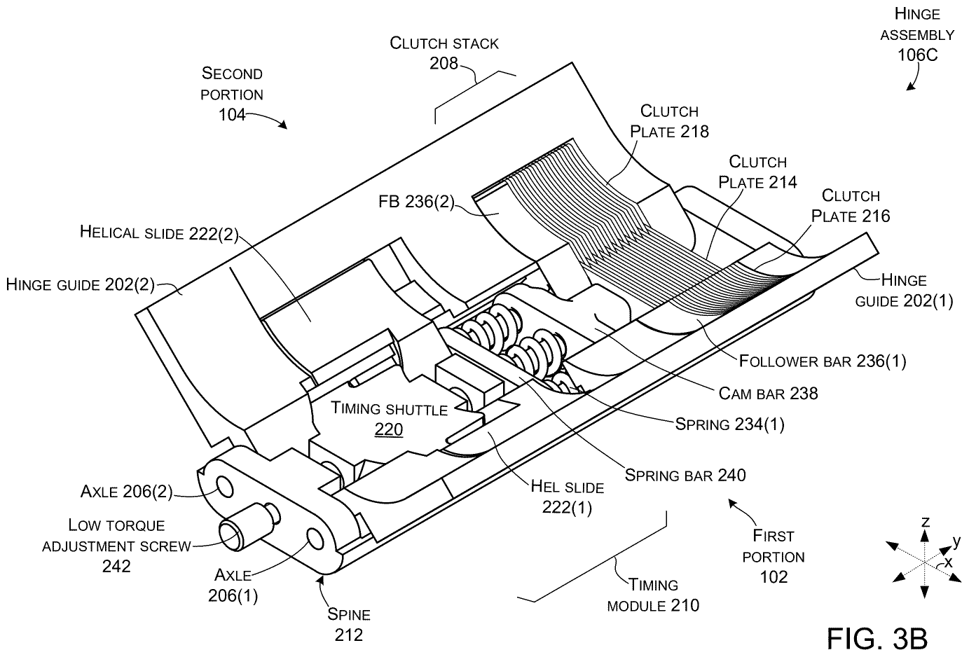

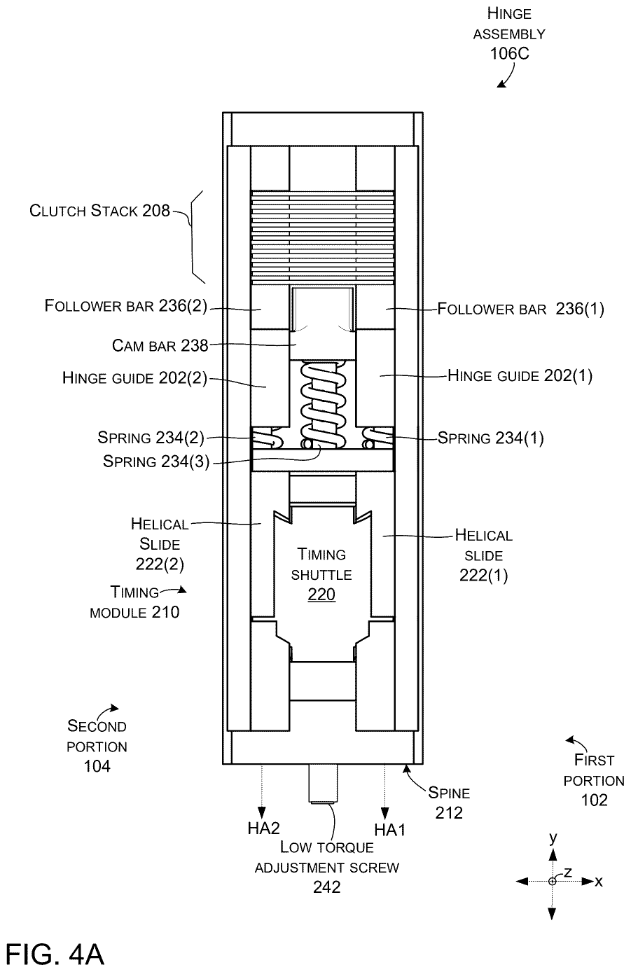

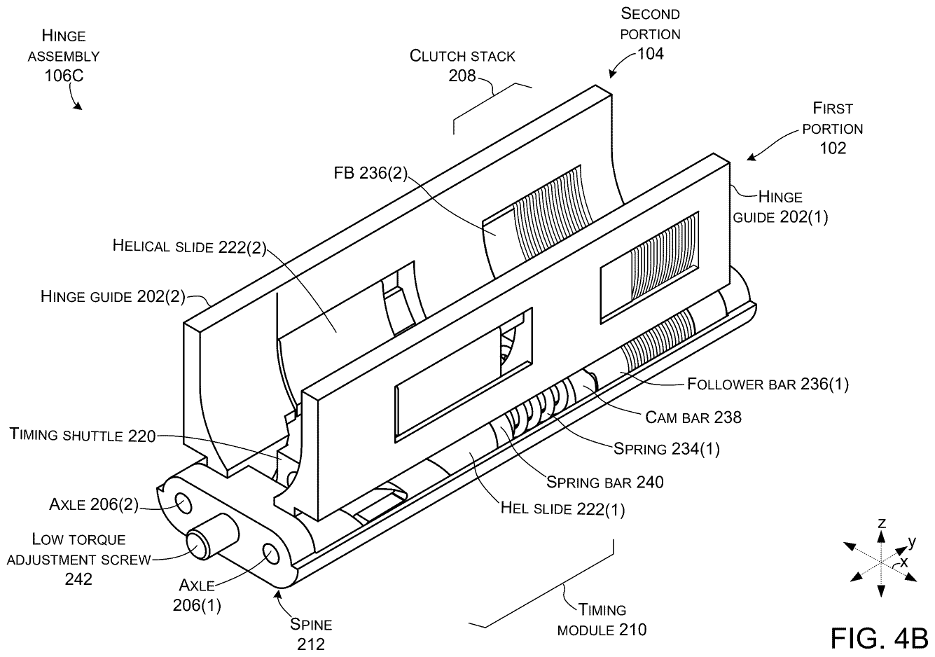

FIGS. 2A-2F, 3A-3B, and 4A-4B collectively show details of an example hinge assembly 106C. FIGS. 2A-2D show the hinge assembly in a 180-degree orientation, FIGS. 3A and 3B show the hinge assembly in a 90-degree orientation, and FIGS. 4A and 4B show the hinge assembly in a closed or zero-degree orientation. Note that in this implementation, the range of orientations of the hinge assembly is 0 degrees to 180 degrees. Other implementations can have smaller or larger ranges. For instance, the hinge assembly could be configured to rotate from 0 to 100 degrees or 0 to 360 degrees, among other configurations.

In this case, the hinge assembly 106C includes hinge guides 202, axles 206, a clutch stack 208, a timing module 210, and a support cradle or spine 212. (Not all elements are designated in each figure, but the elements listed in this paragraph are designated at least in FIG. 2D unless noted otherwise). The clutch stack 208 can include central clutch plates 214 that are arranged with first side clutch plates 216 and second side clutch plates 218. (Only representative clutch plates are labelled to avoid clutter on the drawing page). In this case, the timing module 210 is manifest as a timing shuttle 220 and helical slides 222. The timing shuttle 220 interacts with helical slides 222 to provide a timing or synchronizing function between the first and second portions. The timing shuttle 220 can define timing surfaces 224 and 226, helical slides 222 can define timing surfaces 228 and hinge guides 202 can define timing surfaces 230.

This hinge assembly 106C also includes a spring assembly 232 in the form of multiple springs 234. Hinge assembly 106C includes follower bars 236, cam bar 238, spring bar 240, and low torque adjustment screw 242. As designated on FIGS. 2E and 2F, the follower bars 236 have a follower surface or profile that includes alternating follower bumps 244 and follower dips 246 that are radially arranged around the axles. The cam bar 238 has a cam surface or profile that includes alternating cam bumps 248 and cam dips 250 that are radially arranged around the axles. To avoid clutter on the drawing page, these elements are only labeled relative to follower bar 236(1) and the corresponding side of the cam bar 238.

Both axles 206(1) and 206(2) secure the clutch plates 214, the cam bar 238, spring bar 240, and timing shuttle 220 within the spine 212 in a non-rotating manner. Axle 206(1) also passes through clutch plates 216, follower bar 236(1), helical slide 222(1), and hinge guide 202(1), which can rotate around the axle. Axle 206(2) also passes through clutch plates 218, follower bar 236(2), helical slide 222(2), and hinge guide 202(2), which can rotate around the axle. The axles 206 define and/or are coextensive with hinge axes (HA) around which the follower bars 236, hinge guides 202, clutch plates 216 and 218, and helical slides 222 can rotate.

Spring 234(1) is positioned on axle 206(1), spring 234(2) is positioned on axle 206(2), and spring 234(3) is positioned on low torque adjustment screw 242. The springs 234 are captive between the cam bar 238 and the spring bar 240. In turn, the helical slides 222 contact the opposite side of the spring bar 240.

The hinge guides 202(1) and 202(2) are secured to the first and second portions 102 and 104, respectively. In some cases, the hinge guides 202 are fixedly secured to the first and second portions. In other cases, the hinge guides 202 can be moveably secured to the first and second portions. As used here, ‘moveably secured’ means that limited linear movement (e.g., sliding or translation) and/or limited rotational movement (e.g., pivoting) can occur between the hinge guides and the first and second portions. In this latter configuration, the motion of the first and second portions is driven or determined by the hinge guide rotation around the axles 206.

Hinge guide 202(1) is secured to the first portion 102 (indicated generally, shown with specificity in FIGS. 1A-1C) and hinge guide 202(2) is secured to the second portion 104 (indicated generally, shown with specificity in FIGS. 1A-1C). Hinge guide 202(1) is positioned in non-rotating relation with helical slide 222(1) (e.g., the helical slide is slideably retained on the hinge guide) and hinge guide 202(2) is positioned in non-rotating relation with helical slide 222(2) (e.g., the helical slide is slideably retained on the hinge guide).

The timing shuttle 220 is positioned on (e.g., bisected by) the low torque adjustment screw 242. Interaction of the timing shuttle's timing surfaces 224 and 226 with the timing surfaces 228 of the helical slides 222 and timing surfaces 230 of the hinge guides 202 substantially synchronizes rotation of the first and second portions 102 and 104. Thus, for example, 40 degrees of rotation of the first portion produces 40 degrees of simultaneous rotation of the second portion (+/− up to 5 degrees due to component tolerances). In this case, timing surfaces 228 of the helical slides 222, and timing surfaces 230 of the hinge guides 202 are axial surfaces. The timing shuttle 220 follows the axial timing surfaces 228 and 230 as it moves parallel to the hinge axes responsive to rotation of either the first and/or second portions.

The position of the timing shuttle 220 in the y reference direction is determined by the interaction of the timing shuttle with the helical slides 222 and the hinge guides 202. Recall that the orientation of the helical slides 222 is determined by the orientation of the hinge guides 202. Thus, the helical timing surfaces 228 and 230 provide a technical solution of moving the timing shuttle 220 along the y-reference axis corresponding to rotation of the first and/or second portions by an amount (e.g., linear distance) determined by engagement of the timing surfaces 224 with the axial timing surfaces 228 and timing surfaces 226 with axial timing surfaces 230.

The timing shuttle 220 provides a technical solution of synchronizing rotation of the first and second portions 102 and 104. For instance, rotation of first portion 102 causes rotation of helical slide 222(1). Rotation of helical slide 222(1) causes engagement of the timing surface 228(1) with the timing shuttle's timing surface 224(1) and timing surface 230(1) with the timing shuttle's timing surface 226(1). The axial shape of these timing surfaces moves the timing shuttle along the y-reference axis. Movement of the timing shuttle along the y-reference axis causes the timing shuttle's timing surface 224(2) to engage surface 228(2) and timing shuttle's timing surface 226(2) to engage timing surface 230(2). Thus, linear movement of the timing shuttle caused by rotation of the first portion causes the timing shuttle to simultaneously rotate helical slide 222(2) and hinge guide 202(2) and hence the second portion an equal number of degrees in the opposite direction and vice versa.

The clutch stack 208 provides a variable friction engine. The amount of rotational friction (e.g., frictional torque) produced by the clutch stack 208 relates to how much force is applied to squeeze or compress the clutch plates together (e.g., more squeezing force results in the clutch stack generating more frictional torque). The springs 234 generate spring force that can squeeze the clutch plates together. The present concepts provide a technical solution in that the amount of spring force applied to the clutch plates is determined by the position of the timing shuttle 220 and the relative relationships of the cam bar 238 and the follower bars 236. In turn, the position of the timing shuttle 220 and the relationship of the cam bar 238 and the follower bars 236 is determined by the orientation of the first and second portions.

From one perspective, the springs 234 create a bias in the y reference direction on the cam bar 238 toward the clutch stack 208, but whether the spring force is conveyed from the cam bar 238 to the follower bars 236 and ultimately to the clutch stack 208 is determined by the orientation of the first and second portions. Thus, the hinge assembly provides orientation-specific rotational friction that is determined by the orientation of the first and second portions through their range of orientations. In this case, the rotational friction can be divided into a relatively high friction sub-range and a relatively low friction sub-range. For instance, the relatively high friction sub-range can entail about 180 degrees to about 15 degrees and the relatively low friction sub-range can entail about 15 degrees to about zero degrees, among other examples.

The timing shuttle 220 also provides a technical advantage in that it offers protection from overload. If one device half (e.g., first or second portion) is forced to rotate out of sync with the other half (e.g., during a device drop), then the helical slide(s) 222 can move to allow the temporary asynchronous motion to occur by further compressing the springs 234. When the overload is released, the spring load will return the device to a synchronized state.

As mentioned above, this implementation employs three springs 234. Spring 234(1) is positioned on axle 206(1) and spring 234(2) is positioned on axle 206(2). Spring 234(3) is positioned between springs 234(1) and 234(2) on the low torque adjustment screw 242. The springs 234 are captive between the cam bar 238 and the spring bar 240. The springs 234 bear on the spring bar 240, which in turn bears on the helical slides 222. The helical slides 222 can move in the axial direction to remove any backlash in the timing provided by the timing shuttle 220. The helical slides 222 are in intimate contact with timing shuttle 220, which in turn is in intimate contact with the hinge guides 202. This spring-loaded intimate contact of the timing surfaces (228 with 224 and 226 with 230) removes any timing backlash from the system (e.g., between the hinge assembly and the first and/or second portions) over the entire range of rotation.

In the illustrated configuration, the three springs 234 also bear on the cam bar 238. In the high friction sub-range of rotation represented by the 90-degree orientation of FIGS. 3A and 3B, the cam bar 238 is free to slide along the axles 206. The cam bar 238 bears on the follower bars 236 which applies load to the clutch stack 208. The interleaved clutch plates 214, 216, 218 of the clutch stack 208 create friction to resist unwanted hinge motion. The high torque friction can be modified by changing the spring load or the number of plates in the clutch stack.

The axial cam system formed between the cam bar 238 and the follower bars 236 provide at least two technical solutions. The first technical solution is to disengage the spring load from the clutch stack 208 in order to provide a low torque for the pop-up angle sub-range (e.g., 0-15 degrees) in the illustrated version. This aspect is reflected by comparing the high torque sub-range represented by the 90-degree orientation in FIGS. 3A and 3B with the low torque sub-range represented by the zero-degree orientation of FIGS. 4A and 4B. The second technical solution is to provide a detent mechanism to snap and hold the device portions in place as the device approaches 180 degrees as shown in FIGS. 2A-2F. This design provides a technical advantage in that in the 180-degree orientation, the detent mechanism can provide a majority of the holding force (e.g., rotational friction). At other orientations, the clutch stack can provide a majority of the holding force (e.g., rotational friction).

Unlike other designs, this hinge assembly 106C provides a technical solution in that it does not require that the timing shuttle 220 unload the clutch stack 208. This is a technical advantage because it reduces forces experienced by the timing shuttle 220 and hence reduces stress on the timing shuttle 220. In addition, the use of axial cams on the timing shuttle 220, the helical slides 222, and the hinge guides 202 gives more flexibility in the transition from the low torque sub-range to the high torque sub-range.

Also, unlike similar designs, the detent mechanism action between the cam bar 238 and the follower bars 236 to unload the clutch stack reduces the spring load. This offers a technical advantage over other designs that increase the spring load while unloading the clutch stack. These other designs limit the maximum working load on the springs during the high torque angle range.

Recall that as shown on FIGS. 2E and 2F, the follower bar 236 includes alternating follower bumps 244 and follower dips 246. The cam bar 238 includes alternating cam bumps 248 and cam dips 250. As the device approaches the fully open 180-degree orientation, the follower bumps 244 on the follower bars 236 can snap into the cam dips 250 in the cam bar 238 to provide the detent mechanism. This can be promoted by selecting a relatively steep cam dip profile. Further, play can be reduced by matching the width of the follower bump 244 with the width of the cam dip 250 so the first and second portions are snuggly held at the 180-degree orientation and don't wobble. Alternatively, the cam can be designed such that the follower sits part way down the slope of the cam (thereby applying a torque) at 180 degrees. Further motion beyond 180 degrees is restricted by another constraint on the hinge guide rotation, often called a ‘stopper’. This configuration also prevents wobble, but between the cam in one direction and the stopper in the other direction.

FIGS. 3A and 3B show the hinge assembly 106C in the 90-degree orientation, which represents the high friction sub-range of rotation. In the high friction sub-range of rotation, the follower bumps 244 on the follower bars 236 are aligned with cam bumps 248 on the cam bar 238. This alignment allows the cam bar to fully transfer spring force to the follower bars 236 and hence to the clutch stack 208. This configuration also forces the cam bar slightly downward against the springs 234. This is evidenced by the low torque adjustment screw 242 being forced slightly downward from the lower end of the spine 212 (e.g., at the opposite end from the clutch stack 208).

FIGS. 4A and 4B show the hinge assembly 106C in the zero-degree orientation, which represents the low friction sub-range of rotation. In the low friction sub-range of rotation, the follower bumps 244 on the follower bars 236 fall into the cam dips 250 in the cam bar 238, allowing the cam bar 238 to slide further towards the follower bars 236 (move in the positive y reference direction (e.g., toward the top of the drawing page)). However, the cam bar's motion is limited by the low torque adjustment screw 242 such that the spring load is carried through the low torque adjustment screw 242 rather than being applied to the follower bars 236. The clutch stack 208 is not loaded, resulting in a low friction torque condition.

This aspect can be seen by comparing FIGS. 3A and 3B where the base of the low torque adjustment screw is forced away from the spine as the cam alignment transfers spring energy along a ‘path’ through the cam bar 238 into the follower bars 236, which in turn compress the clutch stack against the spine. In contrast, in FIGS. 4A and 4B, the alignment of the cam and cam followers creates a gap in the ‘path’ between the cam bar 238 into the follower bars 236. To complete the path the cam bar 238 would have to move upward toward the follower bars 236 to convey the spring force to the clutch stack 208. However, this upward movement of the cam bar 238 is limited by the low torque adjustment screw 242, which is threaded into the cam bar 238. The extent of the upward movement of the cam bar 238 is stopped when the base of the low torque adjustment screw 242 contacts the spine 212.

The threaded relationship of the cam bar 238 and the low torque adjustment screw 242 provides adjustability to define the low friction sub-range of rotation. For instance, screwing the low torque adjustment screw 242 farther into the cam bar 238 shortens the length of the low torque adjustment screw 242 between its base and the cam bar 238. This will increase the low friction sub-range. For instance, if the low friction sub-range is initially set at zero degrees to ten degrees, screwing the low torque adjustment screw 242 farther into the cam bar 238 can increase the low friction sub-range to zero degrees to 15 degrees, for example. The ability to control the low friction range can be limited by the shape of the cam. If the cam slope is shallow then a large angle adjustment can be made. Some cam designs include a fixed opening angle. Further adjustment can account for manufacturing variation in the y reference direction length of the many components involved in the load path. In this case the adjustment could be made to establish a proper gap between the cam and follower to ensure that the load path is interrupted in the low friction range.

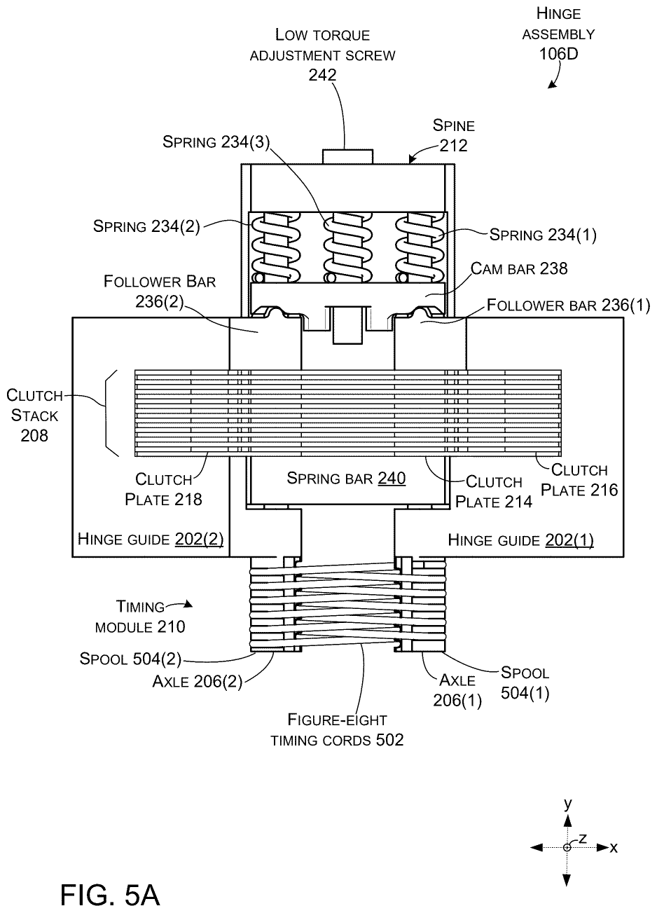

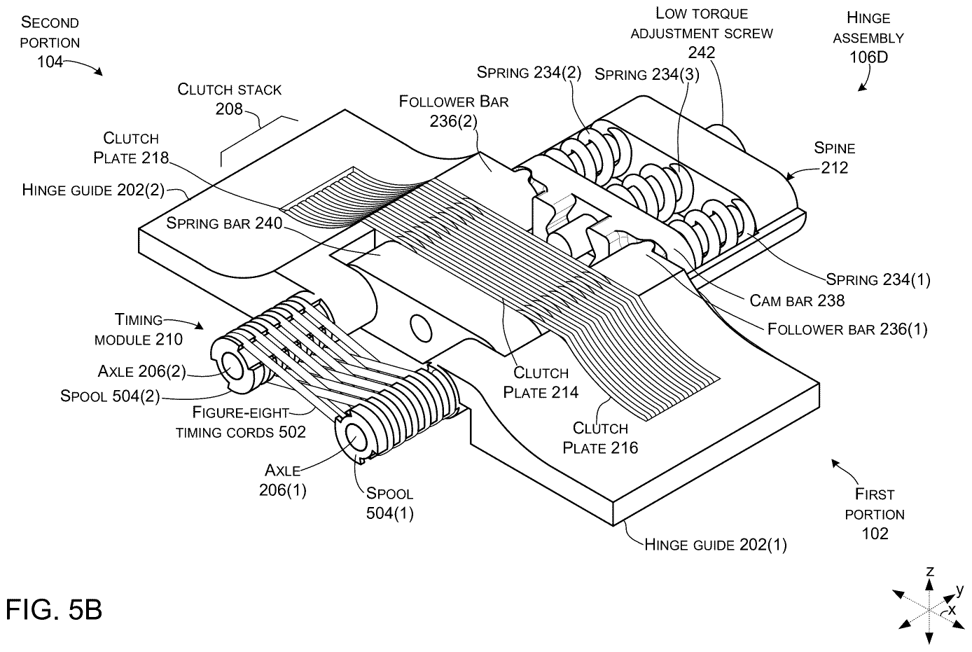

FIGS. 5A and 5B show another example hinge assembly 106D at a 180-degree orientation. In this configuration, the follower bars 236 are integrated into hinge guides 202. The spring bar 240 is positioned on the opposite side of the clutch stack 208 from the cam bar 238. The low torque adjustment screw 242 passes through spine 212 and spring 234(3), and is threaded into cam bar 238. The low torque adjustment screw 242 can be adjusted to adjust the position of the cam bar 238 (in the y reference direction).

In the high friction sub-range when the follower bumps 244 are aligned with the cam bumps 248 (FIGS. 2E and 2F), spring force is transferred from the springs 234, to the cam bar 238, to the follower bars 236, and to the clutch stack 208. However, in the low friction sub-range, the follower dips 246 are aligned with the cam bumps 248 (FIGS. 2E and 2F) and the cam bar 238 is constrained from moving toward the follower bars 236 by the base of the low torque adjustment screw 242 contacting the spine 212. Thus, less or no spring force is applied to the clutch stack 208 and the hinge assembly 106D provides relatively low resistance to rotation.

In the 180-degree orientation, the interaction of the cams of the cam bar 238 and the cam followers of the follower bars 236 (e.g., follower bumps 244 aligned with cam dips 250) function as a detent mechanism to provide a bias to maintain the 180-degree orientation. This bias can be overcome by the user applying enough rotational force to cause the follower bumps 244 to ride up out of the cam dips 250 and compress the springs 234 (e.g., move into the high friction sub-range). In some implementations the cams can be designed such that clutch stack friction is reduced partially or fully at the detent. Alternatively, it could be designed so that nearly full friction is maintained. This could be done by designing the cam such that it still maintains contact with the follower at the 180-degree orientation even though the follower is partially down the slope of the cam.

The present concepts provide a technical solution in that radial arrangement of the follower bumps 244 cam dips 250, and cam bumps 248, allows the orientation of the first and second portions to determine their relative alignment. Thus, when the first and second portions are oriented at 180 degrees, the follower bumps 244 and the cam dips 250 provide a detent mechanism. In the high friction sub-range, the follower bumps 244 are aligned with the cam bumps 248 to complete a path for spring force to be conveyed to the clutch stack. In the low friction sub-range, the alignment of the follower bumps with the cam dips limits spring force conveyance.

Hinge assembly 106D also employs a different timing module 210. In this case, the timing module 210 is manifest as one or more figure-eight cords 502 that are positioned around the axles 206, either directly or on spools 504. The figure-eight cords 502 can be configured in a non-slipping relation with the axles to synchronize axle rotation during normal device operation. For instance, rotation of the first portion causes rotation of axles 206(1), which causes rotation of the figure-eight cords 502, which in turn rotates axle 206(2) and the second portion. The figure-eight cords can provide synchronized timing with very little backlash (e.g., play or slop) in the system (e.g., between the first portion, the hinge assembly, and the second portion). The figure-eight cords can be associated with the axles so that during a traumatic stress event, such as a drop, the cords can slip relative to the axles to reduce/prevent damage to the hinge assembly.

Multiple configurations can be employed. For instance, a single cord shaped into a single figure-eight could be employed. Alternatively, multiple cords, which each make a single figure-eight wrap could be employed (e.g., they can be adjacent to one another along the y reference axis in a non-overlapping arrangement). Alternatively, a single cord can make multiple figure-eight wraps in a shoelace fashion (e.g., adjacent wraps progressing along the y reference axis in a non-overlapping arrangement). In some of these configurations, each figure-eight may be secured to the spool with glue, weld, or solder, which allows each pass (e.g., loop on the spool) to act independently.

The figure-eight cords 502 can be made from various materials, such as metals or polymers and may entail a single strand or multiple strands. Dyneema is an example of a relatively strong, low stretch cord material that can be employed. Another example is steel wire rope, such as 7×7 steel wire rope with a 0.27 mm diameter. A steel cable can be welded or soldered, a synthetic cable can be glued. Alternatively, crimps can be applied to each end of a fixed length of cable. Then the cable can be tensioned while the crimp is fastened to the hinge guide via glue, weld, etc.

Individual device elements can be made from various materials, such as metals, plastics, and/or composites. These materials can be prepared in various ways, such as from formed sheet metals, die cast metals, machined metals, 3D printed materials, molded or 3D printed plastics, and/or molded or 3D printed composites, among others, and/or any combination of these materials and/or preparations can be employed.

The present hinge assembly concepts can be utilized with any type of device, such as but not limited to notebook computers, smart phones, wearable smart devices, tablets, and/or other types of existing, developing, and/or yet to be developed devices.

Various methods of manufacture, assembly, and/or use for hinge assemblies and devices are contemplated beyond those shown above relative to FIGS. 1A-5B.

Although techniques, methods, devices, systems, etc., pertaining to hinge assemblies are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

Various examples are described above. Additional examples are described below. One example includes a device comprising a first portion secured to a first hinge guide that is configured to rotate relative to a first axle and defines a first axial timing surface and a second portion secured to a second hinge guide that is configured to rotate relative to a second axle and defines a second axial timing surface, a clutch stack spanning the first axle and the second axle, a timing shuttle positioned between the first and second axles, the timing shuttle configured to engage the first and second axial timing surfaces to synchronize rotation of the first and second portions through a range of rotation, and orientation dependent cams that limit compression of the clutch stack at a first sub-range of the range of rotation and facilitate compression of the clutch stack at a second sub-range of the range of rotation.

Another example can include any of the above and/or below examples where the device further comprises a first display positioned on the first portion and a second display positioned on the second portion, or further comprising a single display that extends across both the first portion and the second portion.

Another example can include any of the above and/or below examples where the device further comprises a first helical slide that is associated with the first hinge guide and defines a third axial timing surface and a second helical slide that is associated with the second hinge guide and defines a fourth axial timing surface.

Another example can include any of the above and/or below examples where the timing shuttle is captive between the first and third axial timing surfaces and the second and fourth axial timing surfaces.

Another example can include any of the above and/or below examples where the device further comprises springs positioned between the clutch stack and the timing shuttle.

Another example can include any of the above and/or below examples where the springs bias the third and fourth axial timing surfaces toward the first and second axial timing surfaces.

Another example can include any of the above and/or below examples where the springs bias the orientation dependent cams toward the clutch stack.

Another example can include any of the above and/or below examples where the orientation dependent cams are positioned on a cam bar that is positioned on the first and second axles and comprise a first orientation dependent cam positioned around the first axle and a second orientation dependent cam positioned around the second axle.

Another example can include any of the above and/or below examples where the first orientation dependent cam comprises alternating cam bumps and cam dips radially arranged around the first axle and the second orientation dependent cam comprises alternating cam bumps and cam dips radially arranged around the second axle.

Another example can include any of the above and/or below examples where the device further comprises a first follower bar positioned around the first axle and configured to rotate with the first hinge guide, the first follower bar comprising alternating follower bumps and follower dips radially arranged around the first axle.

Another example can include any of the above and/or below examples where the follower bumps are aligned with cam dips in the first sub-range of the range of rotation to transfer less spring force to the clutch stack to create relatively low resistance to rotation.

Another example can include any of the above and/or below examples where the cam bumps are aligned with follower bumps in the second sub-range of the range of rotation to transfer more spring force to the clutch stack to create relatively high resistance to rotation.

Another example can include any of the above and/or below examples where at a 180-degree orientation follower bumps are aligned with sloping surfaces of cam dips to create a detent bias to maintain the first and second portions at the 180-degree orientation.

Another example includes a device comprising a first portion associated with a first axial timing surface and a second portion associated with a second axial timing surface, a clutch stack spanning between the first portion and the second portion, a timing shuttle configured to engage the first and second axial timing surfaces to synchronize rotation of the first and second portions through a range of rotation, and orientation dependent cams that control compression of the clutch stack as the first and second portions rotate through the range of rotation.

Another example can include any of the above and/or below examples where the first axial timing surface is defined by a first helical slide that is slideably retained in a first hinge guide that is secured to the first portion, and wherein the second axial timing surface is defined by a second helical slide that is slideably retained in a second hinge guide that is secured to the second portion.

Another example can include any of the above and/or below examples where first hinge guide defines a third axial surface and the second hinge guide defines a fourth axial surface and further comprising springs that bias the timing shuttle between the first and second helical slides and the first and second hinge guides.

Another example can include any of the above and/or below examples where the orientation dependent cams are configured to convey force from the springs to the clutch stack in a high friction sub-range of rotation and configured to not convey the force from the springs to the clutch stack in a low friction sub-range of rotation.

Another example includes a device comprising a timing module configured to synchronize rotation of first and second device portions having a flexible display extending therebetween, a clutch stack configured to impart resistance to rotation upon the first and second portions, and orientation dependent cams that are configured to impart a greater compressive force on the clutch stack in a first sub-range of rotation and to impart a lesser compressive force on the clutch stack in a second sub-range of rotation that includes a closed orientation where the flexible display is bent between the first and second portions.

Another example can include any of the above and/or below examples where the timing module comprises a timing shuttle or wherein the timing module comprises a figure-eight timing cord.

Another example can include any of the above and/or below examples where the clutch stack and the orientation dependent cams are positioned on axles and wherein the figure-eight timing cord is positioned around the axles.

Another example can include any of the above and/or below examples where the figure-eight cord is positioned directly on the axles or wherein spools are positioned on the axles and the figure-eight cord is positioned on the spools.

Another example can include any of the above and/or below examples where the figure-eight cord comprises a single figure-eight timing cord.

Another example can include any of the above and/or below examples where the single figure-eight timing cord makes a single figure-eight around the axles or wherein the single figure-eight timing cord makes multiple figure-eight wraps around the axles.

Another example can include any of the above and/or below examples where the figure-eight timing cord comprises multiple figure-eight timing cords that each make one figure-eight wrap around the axles.

1. A device, comprising:
a first portion secured to a first hinge guide that is configured to rotate relative to a first axle and defines a first axial timing surface and a second portion secured to a second hinge guide that is configured to rotate relative to a second axle and defines a second axial timing surface;
a clutch stack spanning the first axle and the second axle;
a timing shuttle positioned between the first and second axles, the timing shuttle configured to engage the first and second axial timing surfaces to synchronize rotation of the first and second portions through a range of rotation; and,
orientation dependent cams that limit compression of the clutch stack at a first sub-range of the range of rotation and facilitate compression of the clutch stack at a second sub-range of the range of rotation.

2. The device of claim 1, further comprising a first display positioned on the first portion and a second display positioned on the second portion, or further comprising a single display that extends across both the first portion and the second portion.

3. The device of claim 1, further comprising a first helical slide that is associated with the first hinge guide and defines a third axial timing surface and a second helical slide that is associated with the second hinge guide and defines a fourth axial timing surface.

4. The device of claim 3, wherein the timing shuttle is captive between the first and third axial timing surfaces and the second and fourth axial timing surfaces.

5. The device of claim 4, further comprising springs positioned between the clutch stack and the timing shuttle.

6. The device of claim 5, wherein the springs bias the third and fourth axial timing surfaces toward the first and second axial timing surfaces.

7. The device of claim 6, wherein the springs bias the orientation dependent cams toward the clutch stack.

8. The device of claim 7, wherein the orientation dependent cams are positioned on a cam bar that is positioned on the first and second axles and comprise a first orientation dependent cam positioned around the first axle and a second orientation dependent cam positioned around the second axle.

9. The device of claim 8, wherein the first orientation dependent cam comprises alternating cam bumps and cam dips radially arranged around the first axle and the second orientation dependent cam comprises alternating cam bumps and cam dips radially arranged around the second axle.

10. The device of claim 9, further comprising a first follower bar positioned around the first axle and configured to rotate with the first hinge guide, the first follower bar comprising alternating follower bumps and follower dips radially arranged around the first axle.

11. The device of claim 10, wherein the follower bumps are aligned with cam dips in the first sub-range of the range of rotation to transfer less spring force to the clutch stack to create relatively low resistance to rotation.

12. The device of claim 11, wherein the cam bumps are aligned with follower bumps in the second sub-range of the range of rotation to transfer more spring force to the clutch stack to create relatively high resistance to rotation.

13. The device of claim 12, wherein at a 180-degree orientation follower bumps are aligned with sloping surfaces of cam dips to create a detent bias to maintain the first and second portions at the 180-degree orientation.

14. A device, comprising:
a first portion associated with a first axial timing surface and a second portion associated with a second axial timing surface;
a clutch stack spanning between the first portion and the second portion;
a timing shuttle configured to engage the first and second axial timing surfaces to synchronize rotation of the first and second portions through a range of rotation; and,
orientation dependent cams that control compression of the clutch stack as the first and second portions rotate through the range of rotation.

15. The device of claim 14, wherein the first axial timing surface is defined by a first helical slide that is slideably retained in a first hinge guide that is secured to the first portion, and wherein the second axial timing surface is defined by a second helical slide that is slideably retained in a second hinge guide that is secured to the second portion.

16. The device of claim 15, wherein the first hinge guide defines a third axial surface and the second hinge guide defines a fourth axial surface and further comprising springs that bias the timing shuttle between the first and second helical slides and the first and second hinge guides.

17. The device of claim 16, wherein the orientation dependent cams are configured to convey force from the springs to the clutch stack in a high friction sub-range of rotation and configured to not convey the force from the springs to the clutch stack in a low friction sub-range of rotation.

18. A device, comprising:
a timing module configured to synchronize rotation of first and second device portions having a flexible display extending therebetween;
a clutch stack configured to impart resistance to rotation upon the first and second portions; and,
orientation dependent cams that are configured to impart a greater compressive force on the clutch stack in a first sub-range of rotation and to impart a lesser compressive force on the clutch stack in a second sub-range of rotation that includes a closed orientation where the flexible display is bent between the first and second portions.

19. The device of claim 18, wherein the timing module comprises a timing shuttle or wherein the timing module comprises a figure-eight timing cord.

20. The device of claim 19, wherein the clutch stack and the orientation dependent cams are positioned on axles and wherein the figure-eight timing cord is positioned around the axles.

21. The device of claim 20, wherein the figure-eight timing cord is positioned directly on the axles or wherein spools are positioned on the axles and the figure-eight timing cord is positioned on the spools.

22. The device of claim 20, wherein the figure-eight timing cord comprises a single figure-eight timing cord.

23. The device of claim 22, wherein the single figure-eight timing cord makes a single figure-eight around the axles or wherein the single figure-eight timing cord makes multiple figure-eight wraps around the axles.

24. The device of claim 20, wherein the figure-eight timing cord comprises multiple figure-eight timing cords that each make one figure-eight wrap around the axles.
